(19) United States
(12) Patent Application Publication
(10) Pub. No.: US 2002/0117901 A1
(43) Pub. Date: Aug. 29, 2002

(54) Flame containment and suppression baffle structure for electronic circuit board cabinet

(75) Inventors: James R. Spivey, Morrisville, NC (US); Jeffrey L. Howell, Raleigh, NC (US); Floyd G. Speraw, Anderson, SC (US)

Correspondence Address: CHRISTOPHER F. REGAN, ESQUIRE, ALLEN, DYNER, DOPPELT, MILBRATH & GILCHRIST, P.A., P. O. Box 3791, Orlando, FL, 32802-3791, US

(73) Assignee: Pliant Systems, Inc., Research Triangle Park, NC (US)

(21) Appl. No.: 09/791,289

(22) Filed: Feb. 23, 2001

(51) Int. Cl. F16P 7/02

(52) U.S. Cl. 307/117

(57) ABSTRACT

A flame containment and suppression baffle architecture for a card cage of an electronic circuit cabinet includes a baffle structure having a pivotable flap that is retained by a meltable solder attachment in an open position, that normally allows cooling air, either convection or forced fed, to exit the card cage housing. In the event of a fire in the card cage, any flame or heat therefrom is steered by a set of guide rails along a canted baffle deflector, to the solder attachment. This focusing of heat upon the solder attachment causes the solder to melt quickly, so that the flap is released and rotates downwardly to a second (vertical) position against the air vents, closing the only exit for the flame and smoke. Smoke soon backs up until it starves the flame of oxygen and extinguishes the flame. Where the card cage is equipped with a forced air system, a microswitch may be located above the baffle roof with its actuator passing through a slot in the baffle and resting on the flap. When the flap pivots away from its open position due to melting of the solder, the switch is actuated, cutting the power to the fan, terminating the forced air flow which helps starve the flame from the intake side of the card cage.

### FIELD OF THE INVENTION

The present invention relates in general to electronic systems and components, and is particularly directed to a new and improved baffle architecture that is mountable with the card cage of an electronic circuit cabinet, such as may be employed in a telecommunication equipment installation, and is configured to contain and suppress a hazardous condition, such as a fire, that may occur within the card cage.

### BACKGROUND OF THE INVENTION

In a telecommunications installation environment of the type containing electronic circuit board/card cages mounted (vertically) in racks, there exists a flame containment restriction described in the NEBS test standards. These standards define the limit (in terms of time and distance) to which a flame is permitted to emanate from the confinement of the racked system, in the event of a fire within the card cage(s). Where a card cage contains one or more air baffles between the card cage stacks to manage the convection cooling process, the flame excursion problem is compounded by the fact that an open duct, through which a flame can easily pass, is formed to the rear of the card cage racks. The flame excursion problem is further aggravated when cooling fans are employed to provide forced air systems through the card cages.

In order to determine whether a card cage satisfies the flame test standards, the NEBS test procedure requires the placement in any one of the card slots of a gas fed burner having a sustained flame for a duration of five and one-half minutes and a peak flame height of twelve inches. If this sustained test flame is sufficient to ignite surrounding materials within the card cage, the resulting fire is not permitted to extend out of the rear of the card rack system for more than thirty seconds. Since some card cages are only 5U (8.75″) high, the twelve inch flame on the test burner alone can extend out of the back in violation of the requirements.

### SUMMARY OF THE INVENTION

In accordance with the present invention, the above-described flame containment problem is successfully addressed by coupling an air baffle system having a pivotable flap to the card cage housing. Using a low melt material, such as solder, the pivotable flap is retained in an open position away from air vents in the baffle, that normally allow cooling air, either convection or forced fed, to exit the card cage housing. When a flame is applied inside the card cage, such as a flame from a test burner, or any subsequent fire, it is guided or steered along a set of the canted upsets or guide rails provided along the roof or top of the baffle, so as to focus or direct the major portion of the heat and flame upon the solder attachment.

This focusing of the heat upon the solder causes the solder to melt quickly, and releasing the attachment of the flap to the roof of the baffle. As a result of this release, the flap rotates downwardly to a second (vertical) position against the air vents, closing the only exit for the flame and smoke. Having restricted the means of escape for the smoke and flame, the smoke soon backs up until it starves the flame of oxygen and extinguishes the flame.

Where the card cage is equipped with a forced air system (electrically controlled fan), a micro switch may be located above the baffle roof with its actuator passing through a slot in the baffle and resting on the flap. When the flap pivots away from its normally open position as a result of the melting of the solder, the switch will be actuated, cutting the power to the fan, thus terminating the forced air flow which, in turn, helps to starve the flame from the intake side of the card cage housing.

### BRIEF DESCRIPTION OF THE DRAWINGS

FIG. 1 is a diagrammatic side view of a first embodiment of the card cage-coupled baffle architecture of the invention;

FIGS. 2 and 3 are respective enlarged portions of the side view of FIG. 1;

FIG. 4 is a diagrammatic top perspective view of the first embodiment of the baffle architecture of the invention;

FIG. 5 is a diagrammatic top perspective view of a second embodiment of the baffle architecture of the invention;

FIG. 6 is an enlarged partial side view of the second embodiment of the baffle architecture of the invention.

### DETAILED DESCRIPTION

As pointed out briefly above, the baffle architecture of the present invention is operative to contain and suppress a hazardous condition, in particular a fire, that may occur within the card cage or rack of an electronic circuit cabinet, such as that employed in a telecommunication equipment installation. Once installed in the card cage, the baffle is effective to prevent heat dissipated from a lower card cage in the rack from passing convectively through additional card cages stacked above it.

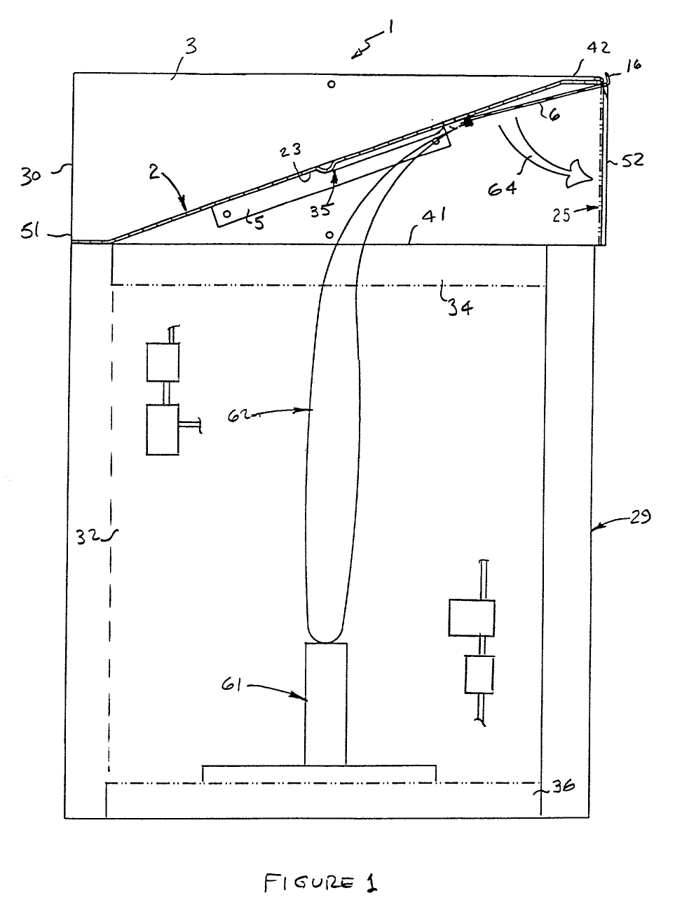

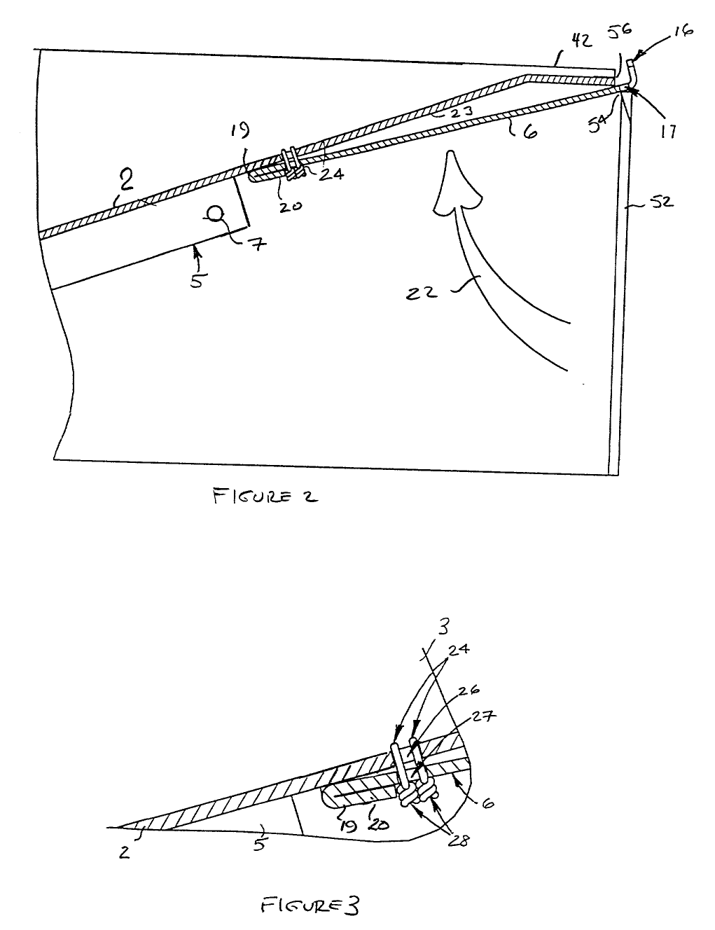

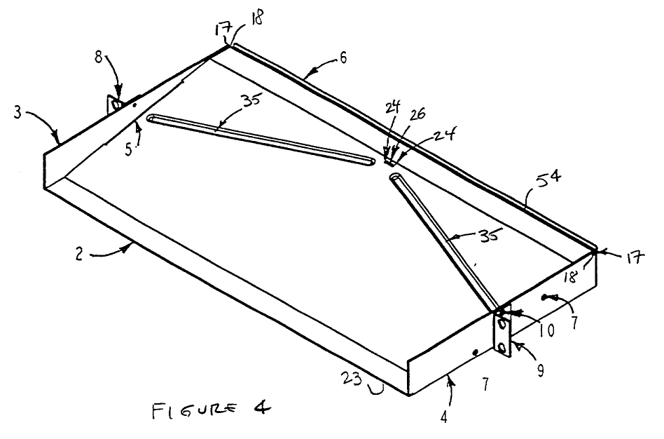

A first embodiment of the invention, intended to be employed with a card cage having a non-forced convection cooling air flow, is diagrammatically shown in the side view of FIG. 1, the enlarged partial side views of FIGS. 2 and 3, and the top perspective view of FIG. 4. Pursuant to this first embodiment, the baffle 1 is preferably dimensioned as a 1U (1.75″0 high) structure, and is made of a relatively rigid, robust, fire resistance material, such as steel or aluminum, as non-limiting examples, being configured to be mounted at an upper region 30 of a printed circuit card cage 29, in which a plurality of printed circuit boards or cards, one of which is diagrammatically shown at 32, are vertically installable, such as by means of upper and lower guide rails 34 and 36, respectively.

The air baffle 1 proper includes a left side plate 3 and a right side plate 4, that are respectively attached to opposing flanges (one of which is shown at 5) of a slightly canted or inclined deflector 2, by means of suitable fasteners, such as with rivets, screws or the like 7. Respective left and right cage-mounting tabs 8 and 9 are affixed to side plates 3 and 4 (by means of suitable hardware fasteners 10, such as rivets, as a non-limiting example) to facilitate mounting the baffle to a card cage rack.

The deflector 2 extends upwardly from a front portion 51 of the baffle, adjacent to an open interface 41 with the card cage 29 therebeneath, to a vented or air slot-containing rear end wall region 52 adjacent to the top 42 of the baffle. As shown in the top perspective view of FIG. 4, the underside 23 of the deflector 2 is provided with a pair of embossed ribs 35, that form a pair of angled guide channels terminating adjacent to a slot or hole 26 through the deflector 2, through which a meltable material attaches a foldable closure or flap 6 to the deflector proper. As will be described, the angled ribs 35 serve to guide any heat and flame emanating beneath the baffle, both convectively and conductively, along the underside of the deflector, and focussing it at the solder attachment location 26, so that the attachment solder will be quickly melted and release the flap.

As shown in FIGS. 1 and 2, the pivotable or rotatable closure or flap 6 is inserted through a generally transverse slot 54 along the upper portion of the rear wall 52. The flap 6 preferably has a length approximating the height of the rear wall 52 so that, when rotated about transverse slot 54 to a vertical position, shown at 25 in FIG. 1, it will close and prevent air flow through the rear vent portion of the baffle. An upper edge of the flap 6 has a flange 16 that limits insertion of the flap through the transverse slot 54. Extending from opposite side edges of the flap 6 adjacent to the flange 16 are a pair of tabs 17 that rest in associated slots 18 in the left and right side plates 3 and 4, respectively, and provide a fulcrum about which the flap is allowed to pivot or rotate downwardly.

The partial enlarged view of FIG. 3 shows a lower or front end 19 of the flap 6 having a folded back and crimped portion 20 for added structural rigidity and weight to facilitate rapid rotation of a released flap away from the underside 23 of the deflector 2 toward its closed position 25. Once the flap 6 has been inserted through the transverse slot 54, it is pivoted clockwise as shown by the arrow 22, until its front end 19 touches the under side 23 of the deflector 2. A strip (or strips) of solder 24 is passed through one or more holes 26 in the deflector 2 and associated holes 27 in the flap 6, and twisted together as shown at 28, to secure the flap 6 against to the bottom side 23 of the deflector 2.

Referring to FIG. 1, when a burner 61 is placed within an arbitrary card slot location within the card cage 29, and produces a flame 62 per the NEBS Test procedure, heat from the flame and the flame proper are guided (convectively and conductively) along the angled embossed ribs 35 that extend along the underside 23 of the deflector 2. The guided heat and flame are thereby focussed upon the twisted solder terminations 28 projecting centrally in the path of the heat and flame. This application of heat and flame melts the twisted solder, releasing the flap 6 and allowing it to freely pivot or rotate away from the underside of the deflector 2 and fall, pivoting on the tabs 17, in a counter-clockwise direction as shown by arrow 64, until the flap abuts against rear flange 52 of the baffle in its vertical position 25. This action closes the only means of escape for the heat and flame, thus trapping the smoke inside the cabinet until it builds enough back pressure to choke out the flame.

As described briefly above, in a card cage that employs a forced air system to enhance convection cooling of its components, it is also necessary to shut off the cooling fans (not shown), typically located beneath the bottom card cage. For this purpose, the baffle structure of the first embodiment described above is modified to incorporate an auxiliary cut-off (micro) switch in circuit with the electrical power to the forced air system. When the flap pivots away from its normally open position as a result of the melting of the solder, this auxiliary microswitch is actuated, cutting the power to the fan, thus terminating the forced air flow which, in turn, helps to starve the flame from the intake side of the card cage housing.

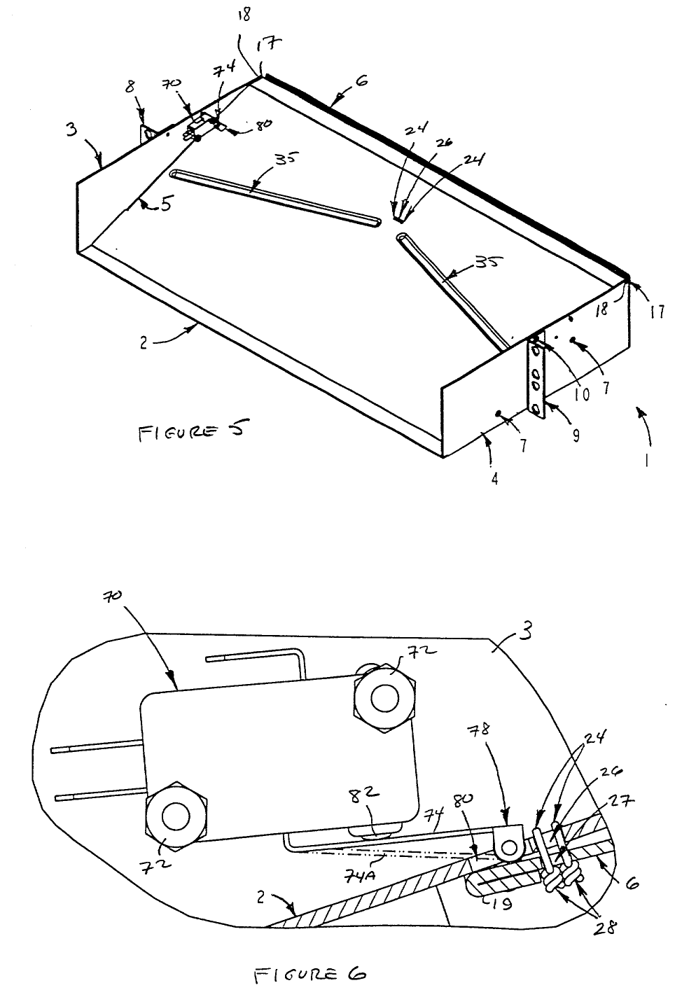

This cut-off switch enhancement provided by the second embodiment of the invention may be readily understood by reference to the additional diagrammatic top perspective view of FIG. 5 and the enlarged partial side view of FIGS. 6. In order to facilitate the present description, those components of the second embodiment of the invention which are identical to the first embodiment of FIGS. 1-4 are identified in FIGS. 5 and 6 by the same reference numerals and will not be additionally described here. Instead, the present description will detail the specifics of the cut-off switch enhancement provided by the second embodiment.

To provide room for the incorporation of the cut-off switch, the baffle of the second embodiment may be dimensioned as a 2U (3.50″ high) structure, as a non-limiting example. The cut-off switch of the second embodiment is shown at 70 as having a standard microswitch configuration, and is mountable by way of suitable fasteners 72, such as screws and the like, to one of the side plates, such as the side plate 3, as shown. As shown in the partial enlarged view of FIG. 6, a switch arm 74 extending from the body 70 of the switch has a terminal end 78 that passes through an aperture 80 in the deflector 2 and rests against the top of the front end 19 of the flap 6, described above.

In this position, with the flap 6 solder-attached to the underside 23 of the deflector 2, the switch arm 74 is urged against the switch's actuator button 82, so that the electrical circuit in which the switch 70 is installed for powering the cage cooling fan is enabled. However, when the twisted solder terminations 28 are melted as a result of the focussed incidence of heat/flame as described above, as the flap 6 falls to the vertical position 25, the switch arm 74 is now free to move to its open position, shown at dot-dashed lines 74A. With the switch 70 opened, power to the forced air cooling system is severed, terminating the forced supply of oxygen from the intake side of the card cage, thus helping to extinguish the flame. As noted above, with the flap 6 having pivoted down to its closed position 25, the only means of escape for the heat and flame is blocked, causing smoke to be trapped inside the cabinet until it builds enough back pressure to choke out the flame.

While we have shown and described several embodiments in accordance with the present invention, it is to be understood that the same is not limited thereto but is susceptible to numerous changes and modifications as known to a person skilled in the art. We therefore do not wish to be limited to the details shown and described herein, but intend to cover all such changes and modifications as are obvious to one of ordinary skill in the art.

What is claimed:

1. A hazardous condition containment and suppression arrangement for a housing having a plurality of card slots in which electronic circuit cards are respectively installable, said housing having at least one opening through which a cooling medium for cooling said electronic circuit cards may pass, said arrangement comprising:
a closure supported within said housing adjacent to said at least one opening in a first orientation that allows said cooling medium to pass through said at least one opening, and being positionable to a second orientation that closes said at least one opening; and
a closure control mechanism coupled with said closure, and being arranged to cause said closure to be positioned to said second orientation and thereby close said at least one opening, in response to a prescribed environmental condition within said housing.

2. A hazardous condition containment and suppression arrangement according to claim 1, wherein said cooling medium is fed through said housing by a forced cooling medium feed system, and wherein said closure control mechanism is further operative to interrupt the operation of said forced cooling medium feed system, in response to said prescribed environmental condition within said housing.

3. A hazardous condition containment and suppression arrangement according to claim 2, wherein said closure control mechanism includes a switch coupled with a power circuit for said forced cooling medium feed system, and being arranged to be switched and interrupt the powering of said forced cooling medium feed system, in response to said closure being positioned away from said first orientation.

4. A hazardous condition containment and suppression arrangement according to claim 1, wherein said closure control mechanism comprises a temperature sensitive element coupled with said closure, and being arranged to cause said closure to be positioned to said second orientation and thereby close said at least one opening in response to sensing a prescribed temperature within said housing.

5. A hazardous condition containment and suppression arrangement according to claim 4, wherein said temperature sensitive element comprises a meltable material that is arranged to normally retain said closure in said first orientation and, in response to an increase in temperature sufficient to melt said meltable material, is operative to allow said closure to move to said second orientation, and thereby close said at least one opening.

6. A hazardous condition containment and suppression arrangement according to claim 5, wherein said cooling medium is fed through said housing by a forced cooling medium feed system, and wherein said closure control mechanism includes a switch coupled with a power circuit for said forced cooling medium feed system, and being arranged to be switched and interrupt the powering of said forced cooling medium feed system, in response to said closure being positioned away from said first orientation as a result of melting of said meltable material.

7. A hazardous condition containment and suppression arrangement according to claim 1, wherein said closure includes a baffle adjacent to said plurality of card slots, and having a wall region through which said at least one opening is provided, and a pivotable flap normally retained in first, out-of-the-way position, relative to said at least one opening through said wall region of said baffle, that allows said cooling medium to pass therethrough, but being positioned to a second, closed position against said at least one opening through said wall region of said baffle, so as to prevent said cooling medium from passing therethrough, in response to said prescribed environmental condition within said housing.

8. A hazardous condition containment and suppression arrangement according to claim 7, wherein said closure control mechanism includes a temperature sensitive element coupled with said flap, and being arranged to cause said flap to be positioned to said second orientation and thereby close said at least one opening in response to sensing a prescribed temperature within said housing, and wherein said baffle includes at least one deflector that is configured to direct a flame emanating from the vicinity of said plurality of card slots toward said temperature sensitive element.

9. A hazardous condition containment and suppression arrangement for a housing having a plurality of card slots in which electronic circuit cards are respectively installable, said housing being configured to allow for the circulation of air therein, said arrangement comprising:
a baffle adapted to be mounted with said housing adjacent to said plurality of card slots, and having a wall region through which at least one opening is provided, and a movable closure normally retained in first, out-of-the-way position, relative to said at least one opening, that allows air to pass therethrough, but being positionable to a second, closed position against said at least one opening, preventing air from passing therethrough and thereby constricting air flow into and out of said housing; and
a closure control mechanism coupled with said closure, and being operative to cause said closure to be positioned at said second, closed position and thereby close said at least one opening through said wall region of said baffle, in response to a prescribed environmental condition within said housing.

10. A hazardous condition containment and suppression arrangement according to claim 9, wherein said closure control mechanism includes a temperature sensitive element coupled with said closure, and being arranged to cause said closure to be moved to said second position and thereby close said at least one opening in response to sensing a prescribed temperature within said housing, and wherein said baffle includes at least one deflector that is configured to direct a flame emanating from the vicinity of said plurality of card slots toward said temperature sensitive element.

11. A hazardous condition containment and suppression arrangement according to claim 10, wherein said temperature sensitive element comprises a meltable material that is arranged to normally retain said closure in said first position and, in response to an increase in temperature sufficient to melt said meltable material, is operative to allow said closure to move to said second position, and thereby close said at least one opening.

12. A hazardous condition containment and suppression arrangement according to claim 11, wherein air is fed through said housing by a forced air system, and wherein said closure control mechanism includes a switch coupled with a power circuit for said forced air system, and being arranged to be switched and interrupt the powering of said forced air system, in response to said closure being positioned away from said first position as a result of melting of said meltable material.

13. A flame containment and suppression arrangement for a housing containing a plurality of card slots in which electronic circuit cards are respectively installable, said housing being configured to allow for the circulation of air therein, said arrangement comprising:
a baffle adapted to be coupled to said housing adjacent to said plurality of card slots, and having a wall region through which at least one air-flow opening is provided, and a movable closure normally retained by a meltable attachment in a first, out-of-the-way position, relative to said at least one opening, that allows air to pass therethrough, but being positionable to a second, closed position against said at least one opening, preventing air from passing therethrough and thereby constricting air flow into and out of said housing in response to inability of said meltable attachment to retain said movable closure in said first position; and
a heat and flame deflector coupled with said meltable attachment, and being configured to direct a flame emanating from the vicinity of said plurality of card slots toward said meltable attachment, and thereby cause said closure to be moved to said second, closed position and thereby close said at least one opening through said wall region of said baffle.

14. A flame containment and suppression arrangement according to claim 13, wherein said heat and flame deflector includes one or more guides that are configured to direct a flame emanating from the vicinity of said plurality of card slots toward said meltable attachment, causing said meltable attachment to melt, and thereby enable said closure to be moved to said second, closed position and thereby close said at least one opening through said wall region of said baffle.

15. A flame containment and suppression arrangement according to claim 13, wherein air is fed through said housing by a forced air system, and further including a switch coupled with a power circuit for said forced air system, and being arranged to be switched and interrupt the powering of said forced air system, in response to said closure being positioned away from said first position as a result of melting of said meltable attachment.
